(19) United States
(12) Patent Application Publication
(10) Pub. No.: US 2014/0196918 A1
(43) Pub. Date: Jul. 17, 2014

(54) WATER/FOAM FIRE EXTINGUISHER WITH ADJUSTABLE FOAM CONSISTENCY

(71) Applicant: HNE TECHNOLOGIE AG, Augsburg (DE)

(72) Inventors: Reinhard Effenberger, Affing-Anwalting (DE); Claus Casimir, Munich (DE)

(73) Assignee: HNE TECHNOLOGIE AG, Augsburg (DE)

(21) Appl. No.: 13/702,072

(22) Filed: Dec. 4, 2012

Related U.S. Application Data
(63) Continuation-in-part of application No. PCT/DE2011/001138, filed on May 30, 2011.

(30) Foreign Application Priority Data
Jun. 4, 2010 (DE) 10 2010 022 789.7

(51) Int. Cl. A62C 13/70

(52) U.S. Cl. CPC A62C 13/70
USPC 169/85

(57) ABSTRACT

A portable or wheeled fire extinguishing apparatus which is operable by water or foam, comprising a pressure resistant extinguishing medium container, a pressurized gas bottle for pressurizing the extinguishing medium container for expelling the extinguishing medium, and an extinguishing medium gun which is connected to the extinguishing medium container by a pressure resistant hose, wherein additional pressurized gas can be introduced into the extinguishing medium supplied to the extinguishing medium gun.

This is a continuation-in-part application of pending international patent application PCT/DE2011/001138 filed May 30, 2011 and claiming the priority of German patent application 10 2010 022 789.7 filed Jun. 4, 2010.

### BACKGROUND OF THE INVENTION

Portable or wheeled fire extinguishers with liquid extinguishing mediums, namely water or foam, are known. Also, fire extinguishers in the form of foam extinguishers producing pressurized gas-solidified foam extinguishers are known.

EP 1 197 245 A1 discloses a portable or wheeled fire extinguisher which operates with pressurized gas-solidified foam and which achieves an improved foam solidification in that between the extinguishing medium hose and the extinguishing gun a mixing armature is installed to which a pressurized gas line is connected that is connected via a pressurized gas armature to the pressurized gas bottle in such a way that when pressurized gas is supplied from the pressurized gas bottle to the extinguishing medium container, pressurized gas is also introduced via the mixing armature into the extinguishing agent supply line. Otherwise, the known foam extinguisher consists as usual of a pressure-resistant extinguishing agent container for containing water with an added foaming agent and the pressurized gas bottle as already mentioned coupled to the extinguishing agent container.

With the foam fire extinguisher mentioned above as well as other conventional extinguishers using liquid extinguishing agents operable, with water or foam the way the extinguishing agent is discharged and, as a result, the operation of the extinguisher is predetermined in that water and extinguishing medium are both disposed in the extinguishing medium container. The use of this extinguisher is therefore limited in that the consistency of the extinguishing foam is fixed and cannot be changed. The extinguishing gun operates with a fixed nozzle whose setting is predetermined.

The known foam extinguisher is therefore not universally useable and is suitable for example for extinguishing electrical fires only in a very limited way.

It is therefore the object of the present invention to provide a portable or wheeled foam fire extinguisher which is improved so that the foam consistency is adjustable depending on the needs for extinguishing particular types of fire.

### SUMMARY OF THE INVENTION

A portable or wheeled fire extinguishing apparatus which is operable by water or foam, comprising a pressure resistant extinguishing medium container, a pressurized gas bottle for pressurizing the extinguishing medium container for expelling the extinguishing medium, and an extinguishing medium gun which is connected to the extinguishing medium container by a pressure resistant hose, wherein a mixing armature is installed in the extinguishing medium line between the extinguishing medium container and the extinguishing medium gun and a pressurized gas line is connected to the admixing armature via which, during expulsion of the extinguishing medium from the extinguishing medium container, additional pressurized gas can be introduced into the extinguishing medium supplied to the extinguishing medium gun and wherein the admixing armature includes a switchable admixing valve which can be manually switched by an actuating organ selectively between a closed and an open position.

In the extinguishing apparatus according to claim 1, the present invention the foam solidification can selectively be switched on or off and can be adjusted steplessly between a minimum and a maximum value. The consistency of the foam can therefore be adjusted optimally depending on the needs. If no pressurized gas is introduced into the foam which flows to the nozzle of the extinguishing medium gun, the foam is wet and compact. With the introduction of pressurized gas for foam solidification, the foam is more or less solidified depending on the rate of pressurized gas introduction and is drier, lighter and more stable.

Preferably, the pressurized gas admixing valve for adjusting the foam solidification is attached to the extinguishing medium container so that only a hose extends from the extinguishing medium container, that is from the admixing valve attached to the container, to the extinguishing gun.

The extinguishing gun may advantageously be provided with a switchable nozzle arrangement in order to be able to selectively provide a nozzle delivering a narrow compact droplet jet or a more or less finely atomized wider jet. To this end, in particular a pivot mechanism may be provided to permit selectively the use of a foam tube or a jet spray tube. The foam tube or jet may furthermore be provided at the upstream end thereof with air inlet openings whose opening cross-sections are controllable by an adjustment sleeve steplessly between a fully closed and a fully open position.

In a further development, the fire extinguisher according to the invention includes a separate foaming medium container which can be filled and is arranged separate from the water container. The foaming medium container may be attached at a suitable place at the outside of the water container but it may also be arranged in the interior thereof. The interior of the water container as well as the interior of the foam container can be pressurized by pressurized gas from a pressurized gas bottle for displacing the water and, respectively, the foaming medium from the respective container. The discharge lines of the water container extend to a mixing valve which includes a normally adjustable valve element by which the admixture of foaming medium to the water is controllable. It is also possible to make the admixing of foaming medium to the water controllable in steps or steplessly by providing a corresponding valve element.

An extinguisher according to the invention further developed in this way can then be operated as a pure water extinguisher or a foam extinguisher. During operation as a foam extinguisher, selectively the pressurized gas for the foam solidification may be admixed. The pressurized gas may be added either to the foaming medium before its admission to the water outlet line from the water container so that foaming medium provided with pressurized gas is introduced into the water outlet line. Also, foaming medium and pressurized gas may be directly admixed to the water outlet line at the same location.

As a result, the fire extinguisher according to the invention has decisive advantages:

If the water and the foaming medium are contained in separate containers, the filled extinguisher can be used at the site of operation depending on the conditions encountered, simply by switching over, selectively as pure water fire extinguisher or as a foam fire extinguisher. If the apparatus is to be used as a foam extinguisher, by adjustment of the foam medium- and pressurized gas admixture to the water discharged from the water container the consistency of the foam can be controlled over the whole range between heavy foam and pressurized air foam. Since furthermore the admixture rate of air is variably adjustable at the foam pipe, also the flake size and the moisture of the foam and the foaming rate can be adjusted in a wide range.

Expediently, the fire extinguisher may be designed so that it can rapidly be re-filled by the user during use in that the water container includes a separate water inlet opening provided with a cover which can be opened by hand without the need for a tool and the pressurized gas bottle may be connected to the container group by way of a rapid coupling arrangement which can also be operated by hand without the need for a tool.

An exemplary embodiment of the invention is shown in the accompanying drawings and described below in detail with reference to the accompanying drawings.

### BRIEF DESCRIPTION OF THE DRAWINGS

FIG. 1 is a perspective view of an embodiment of a fire extinguisher according to the invention in a state ready for use.

FIG. 2 shows the fire extinguisher of FIG. 1 in a disassembled state,

FIG. 3 shows the extinguisher gun disconnected from the jet tube change-over arrangement, and

FIG. 4 shows schematically in a block representation an embodiment of a fire extinguisher with separate foam medium and water containers.

### DESCRIPTION OF EXEMPLARY EMBODIMENTS

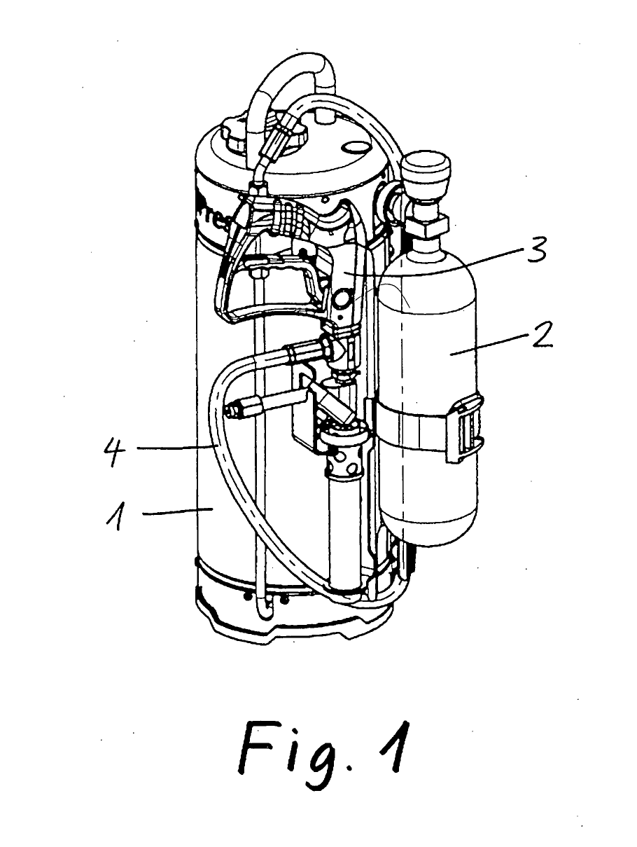

FIG. 1 shows in a perspective view the complete fire extinguisher including an extinguishing medium container 1, a pressurized gas bottle 2 strapped to the container 1 and an extinguisher gun 3 which is inserted into a retaining structure connected to the extinguishing medium container 1 and in communication with the extinguishing medium container 1 via an extinguishing medium hose 4.

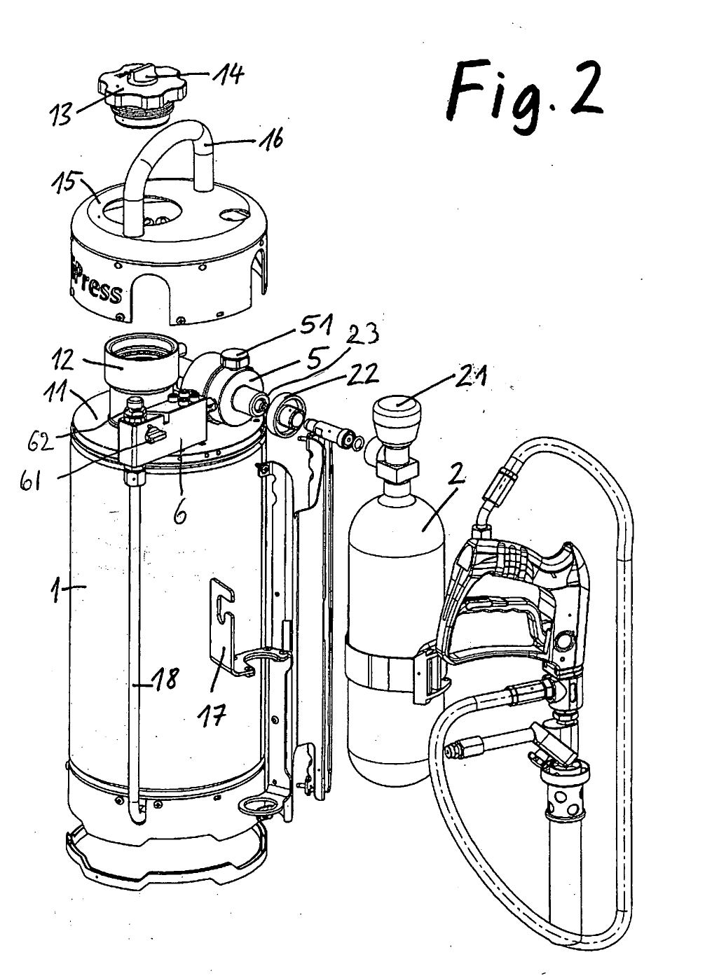

FIG. 2 shows the fire extinguisher of FIG. 1 in an exploded view in order to make also the otherwise covered components visible.

The extinguishing medium container 1 has a top wall 11 provided with an extinguishing medium filler nozzle 12 which projects upwardly from the top wall and via which water and foaming medium can be filled into the extinguishing medium container 1. A closure lid 13 with a pressure relief valve which can be installed and removed by means of a hand wheel without the need for a tool serves as a closing element for closing the filler nozzle 12.

On the top wall 11 of the extinguishing medium container 1, additional components are mounted which will be described below. They are covered by a hood 15 which can be attached to the extinguishing medium container by screws and which is provided with a handle 16.

On the outside of the extinguishing medium container 1, a support structure 17 for holding the extinguisher gun 3 is mounted.

The pressurized gas bottle 2 provided with an outlet valve that can be operated by a hand wheel 21 arranged on top and connectable by a rapid connector 22 for example in the form of a threaded coupling is mounted onto the top wall 11 of the fire extinguishing medium container 1 and is provided at its top with a manometer 51.

Furthermore, an admixing valve block 6 is mounted onto the top wall 11 of the fire extinguisher 1. The valve block 6 includes an admixing valve for the selective admixture of pressurized gas to the extinguishing medium leaving the extinguishing medium container 1. The valve which is disposed in the interior of the valve block 6 and which is not visible in the drawings is manually operable by an operating organ 61.

From the bottom of the extinguishing medium container 1, an extinguishing medium outlet pipe 18 extends to the valve block 6. Furthermore, at the upper connecting stub 62 of the valve block 6 as shown in the figure, the extinguishing medium hose 4 can be connected which extends to the extinguisher gun 3.

From the pressure reducing valve 5, a pressurized gas line which is not visible in the drawing extends into the interior of the extinguishing medium container 1. It extends through the top wall 11 for pressurizing the extinguishing medium contained in the extinguishing medium container 1 for the purpose of forcing the medium out of the extinguishing medium outlet pipe 18. In addition, a pressurized gas line extends from the pressure reducing valve 5 into the valve block 6 to the admixing valve which is contained in the vale block 6 and which is switchable by the operating organ 61 between a closed and an open position. Preferably, the valve is of such a design that the opening cross-section of the pressurized gas line within the valve block is adjustable in a stepless manner between the closed and the fully open position. However, the adjustment may occur in steps. In this way, the foam solidification can be adjusted as desired that is it can be switched on and off and preferably it can be volume-controlled.

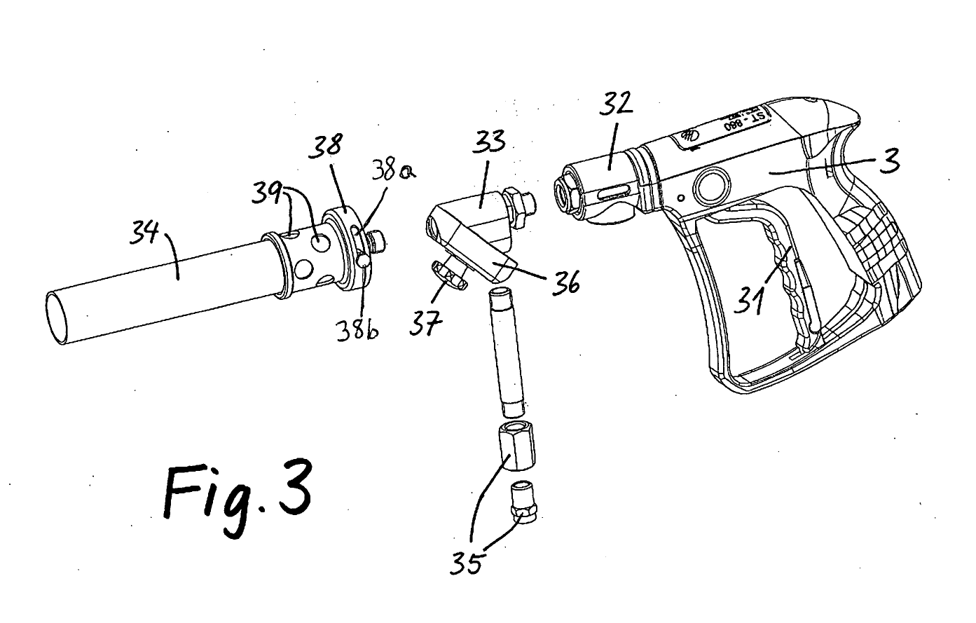

FIG. 3 shows the fire extinguisher gun 3 (without the extinguishing medium hose 4) in a disconnected representation. The gun consists of a gun part 31 with an operating handle provided with a connector 32, a coupling member 33 which can be coupled to the connecter 32, a foam tube 34 and a spray jet tube 35. The foam tube 34 and the spray jet tube 35 are both mounted to the coupling member 33. The coupling member 33 includes a pivot part 36 which can be fixed or released by a hand wheel 37 and which makes a switchover of the respective effective tube, that is, either the foam tube 34 or the spray jet tube 35 for use with the extinguishing gun 3 possible.

At its rear end, the foam tube 34 is provided with a sleeve 38 which has a plurality of openings 39 distributed over the circumference thereof. The rear end of the foam tube has openings corresponding to the openings 39 of the sleeve 38. The sleeve 38 is rotatable over a certain angle of rotation which, as is shown in FIG. 3, is determined by a circumferentially extended elongated opening 38a and a stop screw 38b. The openings 39 of the sleeve 38 can be moved into a position in which the openings in the rear end of the jet tube 34 are completely covered and a position in which the openings are aligned. By rotating the sleeve 38, the openings at the rear end of the foam tube 34 can be closed steplessly or they can be fully or partially opened to facilitate access of ambient air to the foam emitted via the foam tube for further modification of the foam consistency. Instead of the rotatable sleeve, an axially movable sleeve may be provided.

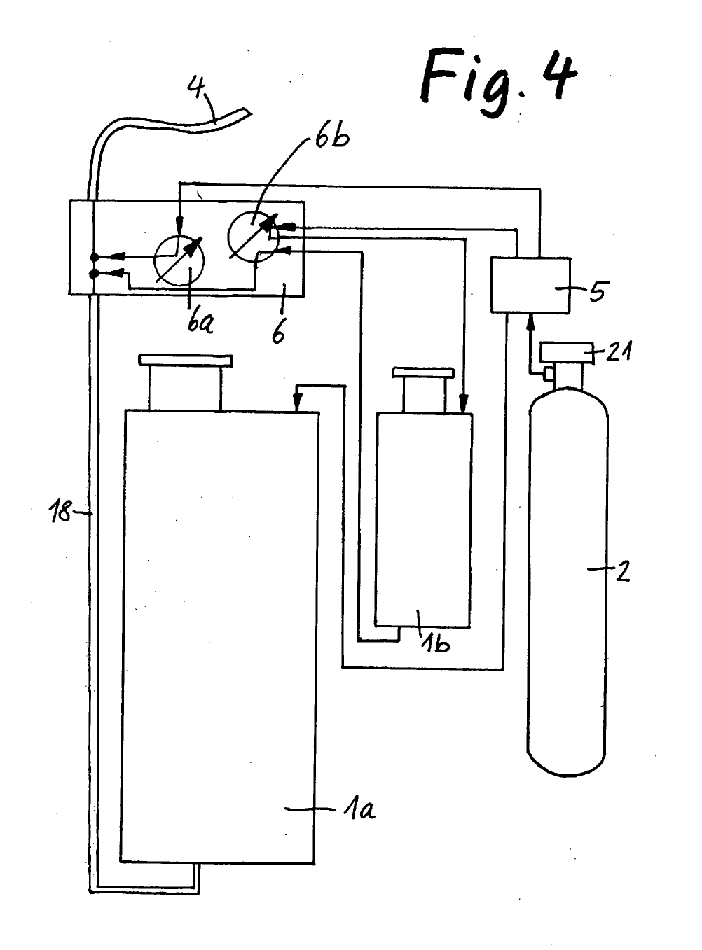

FIG. 4 shows in a schematic representation a further development of the invention in which, in connection with the extinguishing medium container 1, a separate water container 1a and a separate foam medium container 1b are provided.

Since the foam medium part in the water is relatively small during foam extinguishing operation, the foam medium container 1b can be substantially smaller than the water container 1a.

However, it is advantageous if the foam medium container 1b is large enough so that it can accommodate several times the foam medium amount needed for a complete filling of the water container 1a. In this way, during operation of the extinguisher, only water has to be refilled when it has all been used and the extinguisher can continue to operate as a foam extinguisher after a water refill if the foam medium reserve lasts for several water refills.

The foam medium container may be arranged within the water container—of course with its own filler opening or it may be mounted to the outside of the water container at any suitable location at the side, the top or bottom of the water container.

The valve block 6 then includes a manually operable admixing valve 6a for admitting pressurized gas to the discharge line 18 extending from water container 1a to the valve block 6, as well as a manually operable admixing valve 6b for admixing foam medium to the water in the discharge line 18.

The arrangement may be so set up that a pressurized gas line extends from the safety valve 5 directly to the foam medium container 1b so that, there, the foam medium is also pressurized like the water in the water container 1a, or the admixture valve 6b for the foam medium may be combined with a pressurized gas valve (not shown) which, upon switching on the foam medium addition to the extinguisher water, a pressurized gas line, which extends from the safely valve 5 via the valve block 6 to the foam medium container, is at the same time activated so that the foam medium container is pressurized only during foam extinguishing operation of the fire extinguisher.

Also, the admixing valve 6b for admixing foam medium may be so designed, that it is movable either only between an on and an off position, but it is preferably of such a design that it permits a stepped or stepless adjustment for controlling the foam composition, that is the foam medium content in the water.

What is claimed is:

1. A portable or wheeled fire extinguisher which is operable with water or foam, comprising: a pressure resistant extinguishing medium container (1), a pressurized gas bottle (2) for pressurizing the extinguishing medium container (1) for expelling the extinguishing medium, and an extinguishing medium gun (3) which is in communication with the extinguishing medium container (1) via a pressure resistant extinguishing medium hose (4),
the extinguishing medium line extending between the extinguishing medium container (1) and the extinguishing gun (3) including a mixing armature (6) to which a pressurized gas line is connected via which, during expulsion of the extinguishing medium from the extinguishing medium container (1), additional pressurized gas can be admitted to the extinguishing medium supplied to the extinguishing gun (3),
and the mixing armature (6) including a switchable admixture valve (6a) which, by means of an operating organ (61) is manually adjustable selectively between a closed and an open position.

2. The fire extinguisher according to claim 1, wherein the admixing valve is adjustable in a stepwise or stepless fashion between the closed and the open position.

3. The fire extinguisher according to claim 1, wherein the mixing armature (6) is mounted in the form of a valve block to the extinguishing medium container (1) and includes an extinguishing medium inlet connected to an outlet of the extinguishing medium container (1) and an extinguishing medium outlet connected to the extinguishing medium hose (4).

4. The fire extinguisher according to claim 1, wherein the extinguishing medium container (1) includes a separate water container (1a) and a separate foam medium container (16) and wherein the mixing armature (6) is provided with an admixing valve (6b) which is movable between a closed and an open position for a selective admixing of foam medium into a water outlet line (18) extending from the water container (1a).

5. The fire extinguisher according to claim 4, wherein the mixing armature is in the form of a valve block (6) mounted onto the extinguishing medium container (1) and includes the admixing valve (6a) for admixing pressurized gas and an admixing valve (6b) for admixing foam medium to the extinguishing medium.

6. The fire extinguisher according to claim 4, wherein the admixing valve (6b) for admixing the foam medium is adjustable between its closed and its open positions in a stepped or a stepless manner.

7. The fire extinguisher according to claim 4, wherein the admixing of pressurized gas and the admixing of foam medium into the water outlet line (18) of the water container (1a) occurs at a common input location or neighboring input locations.

8. The fire extinguisher according to claim 4, wherein the admixing valve (6b) for the admixing of the foam medium is coupled with a gas pressure valve which, upon opening the foam medium admixing valve (6b), opens the supply of pressurized gas to the foam medium container (1b) for the expulsion of foam medium.

9. The fire extinguisher according to claim 1, wherein the extinguishing gun (3) is provided with a changeover mechanism for connecting at least two different jet tubes, that is, a foam tube (34) and a spray jet tube (35) to the extinguishing medium outlet of the extinguishing gun for effective operation therewith.

10. The fire extinguisher according to claim 1, wherein a foam tube (34) connected to the extinguishing gun is provided in its rear area with a rotatable or axially movable sleeve (38) which has openings (39), and the rear end area of the foam tube (34) is provided with corresponding openings wherein, upon displacing the sleeve (38) by axial sliding or rotation at the rear end of the foam tube (34), the openings of the foam tube are adjustable between a fully closed state in which they are covered by the sleeve (38) and a partially or fully open state in which the openings of the foam tube (34) are aligned with the openings of the sleeve (38).
